(19) United States
(12) Patent Application Publication
(10) Pub. No.: US 2026/0087779 A1
(43) Pub. Date: Mar. 26, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventors: Takaya MIYAMOTO, Tokyo (JP); Akinori Ebihara, Tokyo (JP); Taiki Miyagawa, Tokyo (JP)

(73) Assignee: NEC Corporation, Tokyo (JP)

(21) Appl. No.: 19/327,077

(22) Filed: Sep. 12, 2025

(30) Foreign Application Priority Data
Sep. 20, 2024 (JP) 2024-164047

(51) Int. Cl. G06V 10/764; G06V 10/74; G06V 40/16

(52) U.S. Cl. CPC G06V 10/764; G06V 10/761; G06V 40/172

(57) ABSTRACT

An information processing apparatus includes, an acquisition unit that acquires time-series image data, an index calculation unit that calculates an integrated feature quantity or a score, the integrated feature quantity being obtained by integrating a first feature quantity and a second feature quantity, the score indicating a degree of similarity between the first feature quantity and the second feature quantity, a likelihood ratio calculation unit that calculates a likelihood ratio indicating a likelihood of a class to which the time-series image data belong, and a determination unit that determines that the time-series image data belong to a registered class in a case where the likelihood ratio reaches a first threshold, and determines that the time-series image data belong to an unregistered class indicating that the time-series image data are not registered, in a case where the likelihood ratio reaches a second threshold that is different from the first threshold.

### INCORPORATION BY REFERENCE

This application is based upon and claims the benefit of priority from Japanese Patent Application No. 2024-164047, filed on Sep. 20, 2024, the disclosure of which is incorporated herein in its entirety by reference.

### TECHNICAL FIELD

Example embodiments of a present disclosure relate to an information processing apparatus, an information processing method, and a non-transitory recording medium.

### BACKGROUND ART

A known apparatus of this type performs processing of determining a class to which data belong (so-called class classification). For example, International Publication No. WO2021/229663 discloses a technology/technique of determining a class to which series data serving as a classification target belong, in a case where an individual score or an integrated score calculated based on a likelihood ratio reaches a predetermined threshold.

### SUMMARY

It is an example object of the present disclosure to provide an information processing apparatus, an information processing method, and a non-transitory recording medium for improving the technology disclosed in the background art.

An information processing apparatus according to an example aspect of the present disclosure includes: an acquisition unit that acquires time-series image data; an index calculation unit that calculates an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; a likelihood ratio calculation unit that calculates a likelihood ratio indicating a likelihood of a class to which the time-series image data belong, based on the integrated feature quantity or the score; and a determination unit that determines that the time-series image data belong to a registered class corresponding to the registered image data in a case where the likelihood ratio reaches a first threshold, and determines that the time-series image data belong to an unregistered class indicating that the time-series image data are not registered in advance, in a case where the likelihood ratio reaches a second threshold that is different from the first threshold.

An information processing method according to an example aspect of the present disclosure is an information processing method that is executed by at least one computer, the information processing including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a first threshold, and determining that the time-series image data belong to an unregistered class indicating that the time-series image data are not registered in advance, in a case where the likelihood ratio reaches a second threshold that is different from the first threshold.

A non-transitory recording medium according to an example aspect of the present disclosure is a non-transitory recording medium on which a computer program that allows at least one computer to execute an information processing method is recorded, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a first threshold, and determining that the time-series image data belong to an unregistered class indicating that the time-series image data are not registered in advance, in a case where the likelihood ratio reaches a second threshold that is different from the first threshold.

### BRIEF DESCRIPTION OF THE DRAWINGS

FIG. 1 is a block diagram illustrating a hardware configuration of a first information processing apparatus;

FIG. 2 is a block diagram illustrating a functional configuration of the first information processing apparatus;

FIG. 3 is a flowchart illustrating a flow of operation of the first information processing apparatus;

FIG. 4 is version 1 of a graph illustrating an example of a class threshold, an unregistration threshold, and a likelihood ratio in the first information processing apparatus;

FIG. 5 is version 2 of a graph illustrating an example of the class threshold, the unregistration threshold, and the likelihood ratio calculated by the first information processing apparatus;

FIG. 6 is version 3 of a graph illustrating an example of the class threshold, the unregistration threshold, and the likelihood ratio calculated by the first information processing apparatus;

FIG. 7 is version 4 of a graph illustrating an example of the class threshold, the unregistration threshold, and the likelihood ratio calculated by the first information processing apparatus;

FIG. 8 is a block diagram illustrating a functional configuration of a second information processing apparatus;

FIG. 9 is a flowchart illustrating a flow of a threshold setting operation of the second information processing apparatus;

FIG. 10 is a block diagram illustrating a functional configuration of a third information processing apparatus; and

FIG. 11 is a flowchart illustrating a flow of operation of the third information processing apparatus.

### EXAMPLE EMBODIMENTS

Hereinafter, an information processing apparatus, an information processing method, a computer program, and a recording medium according to example embodiments will be described with reference to the drawings.

### First Example Embodiment

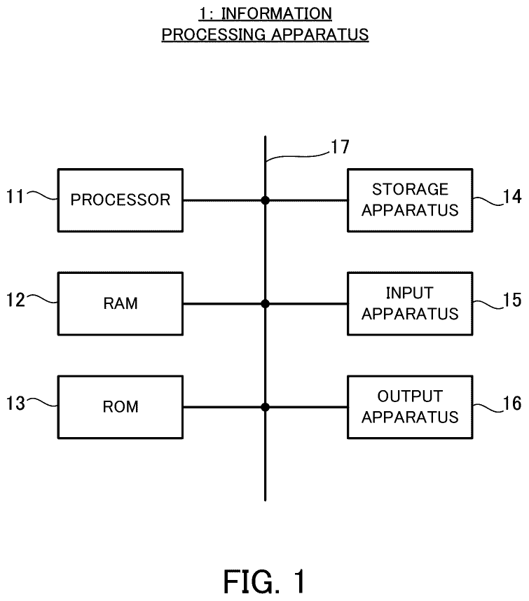

A first information processing apparatus will be described with reference to FIG. 1 to FIG. 7.

### (Hardware Configuration)

First, with reference to FIG. 1, a hardware configuration of the first information processing apparatus will be described. FIG. 1 is a block diagram illustrating the hardware configuration of the first information processing apparatus.

As illustrated in FIG. 1, a first information processing apparatus 1 includes a processor 11, a RAM (Random Access Memory) 12, a ROM (Read Only Memory) 13, a storage apparatus 14, an input apparatus 15, and an output apparatus 16. The processor 11, the RAM 12, the ROM 13, the storage apparatus 14, the input apparatus 15, and the output apparatus 16 described above are connected via a data bus 17. The data bus 17 may be an interface other than a data bus (e.g., a LAN, a USB, etc.).

The processor 11 reads a computer program. For example, the processor 11 is configured to read a computer program stored in at least one of the RAM 12, the ROM 13, and the storage apparatus 14. Alternatively, the processor 11 may read a computer program stored on a computer-readable recording medium, by using a not-illustrated recording medium reading apparatus. The processor 11 may acquire (i.e., read) a computer program from a not-illustrated apparatus disposed outside the first information processing apparatus 1 via a network interface. The processor 11 performs various types of processing by executing the read computer program. When the processor 11 executes the read computer program, a function block related to processing to be performed by the first information processing apparatus 1 is realized in the processor 11. That is, the processor 11 may function as a controller that performs various types of processing and control in the first information processing apparatus 1.

The processor 11 may be configured as, for example, a CPU (Central Processing Unit), a GPU (Graphics Processing Unit), a FPGA (Field-Programmable Gate Array), a DSP (Digital Signal Processor), an ASIC (Application Specific Integrated Circuit), or a quantum processor. The processor 11 may be configured by using one of them, or a plurality of them in parallel.

The RAM 12 temporarily stores the computer program to be executed by processor 11. The RAM 12 temporarily stores data that are temporarily used by the processor 11 when the processor 11 is executing the computer program. The RAM 12 may be, for example, a D-RAM (Dynamic Random Access Memory) or a SRAM (Static Random Access Memory). In addition, another type of volatile memory may be used in place of the RAM 12.

The ROM 13 stores the computer program to be executed by the processor 11. The ROM 13 may also store other fixed data. The ROM 13 may be, for example, a P-ROM (Programmable Read Only Memory) or an EPROM (Erasable Read Only Memory). In addition, another type of nonvolatile memory may be used in place of the ROM 13.

The storage apparatus 14 stores data that are stored by the first information processing apparatus 1 for a long time. The storage apparatus 14 may operate as a transitory storage apparatus of the processor 11. The storage apparatus 14 may store the computer program to be executed by the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the first information processing apparatus 1. The input apparatus 15 may include, for example, at least one of a keyboard, a mouse, a touch panel, and a touch pen. The input apparatus 15 may be an apparatus that allows audio input/voice input, including a microphone, for example.

The output apparatus 16 is an apparatus that outputs information about the first information processing apparatus 1 to the outside. For example, the output apparatus 16 may be a display apparatus (e.g., a display, a monitor, etc.) that is configured to display the information about the first information processing apparatus 1. The output apparatus 16 may also be a speaker that audio-outputs the information about the first information processing apparatus 1, or the like.

The first information processing apparatus may be configured to include only a part of each component described in FIG. 1. For example, the first information processing apparatus 1 may be configured to include only the processor 11, the RAM 12, and the ROM 13 of the above-described components. In this case, each of the storage apparatus 14, the input apparatus 15, and the output apparatus 16 may be provided as an apparatus external to the first information processing apparatus 1. In addition, a part of an arithmetic function of the first information processing apparatus 1 may be realized by an external server, a cloud, or the like.

### (Functional Configuration)

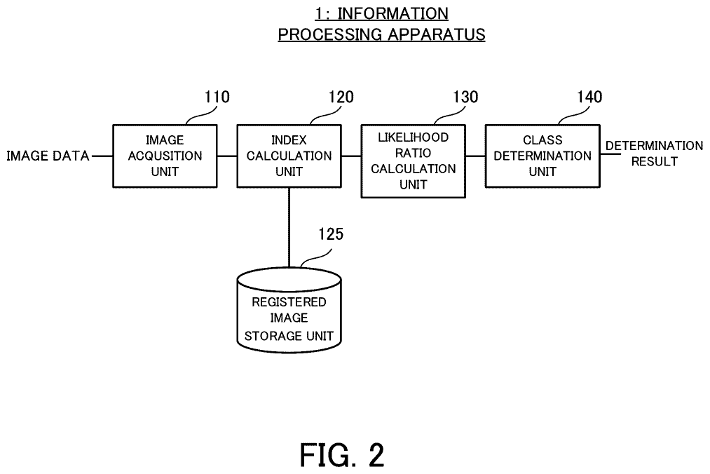

Next, with reference to FIG. 2, a functional configuration of the first information processing apparatus 1 will be described. FIG. 2 is a block diagram illustrating the functional configuration of the first information processing apparatus.

In FIG. 2, the first information processing apparatus 1 is configured as an apparatus that classifies inputted series data. More specifically, the first information processing apparatus 1 is configured to perform matching/verification processing (in other words, authentication processing) of a target included in image data, by classifying inputted time-series image data into a class corresponding to registered image data. The first information processing apparatus 1 includes, as components for realizing its functions, an image acquisition unit 110, an index calculation unit 120, a registered image storage unit 125, a likelihood ratio calculation unit 130, and a class determination unit 140. Each of the image acquisition unit 110, the index calculation unit 120, the likelihood ratio calculation unit 130, and the class determination unit 140 may be a processing block realized by the processor 11 described above (see FIG. 1).

The image acquisition unit 110 is configured to acquire time-series image data. The image acquisition unit 110 may sequentially acquire a plurality of frames of image data. For example, the image acquisition unit 110 may be configured to acquire an image at each frame captured, from a camera that captures a video. The time-series image data acquired by the image acquisition unit 110 are acquired in order to perform the matching processing to registered image data registered in advance. For example, the time-series image data may be face image data including a face of the target. In this case, the acquired face image data may be used to perform face authentication/facial recognition using the face of the target. The face image data are merely an example, and the time-series image data may be image data including a part other than the face of the target (e.g., fingerprints, an iris, etc.). The time-series image data may also include a target other than a person. The time-series image data acquired by the image acquisition unit 110 are outputted to the index calculation unit 120.

The index calculation unit 120 is configured to calculate an integrated feature quantity or a score from the time-series image data acquired by the image acquisition unit 110. The integrated feature quantity is a feature quantity obtained by integrating a first feature quantity that is a feature quantity of the time-series image data and a second feature quantity that is a feature quantity of the registered image data registered in advance. The score indicates a degree of similarity (in other words, a degree of matching) between the first feature quantity and the second feature quantity described above. The index calculation unit 120 may have a function of extracting a feature quantity from the image data in order to calculate the integrated feature quantity or score. For example, the index calculation unit 120 may have a function of extracting a feature quantity of the face of the target from the face image data including the face of the target. The index calculation unit 120 acquires the time-series image data from the image acquisition unit 110, while acquiring the registered image data from the registered image storage unit 125, thereby to calculate the integrated feature quantity or score. The integrated feature quantity or score calculated by the index calculation unit 120 is outputted to the likelihood ratio calculation unit 130.

The registered image storage unit 125 is configured to store the registered image data to be used by the index calculation unit 120 when calculating the integrated feature quantity or score. The registered image storage unit 125 may be configured to store the feature quantity extracted from the registered image data (i.e., the second feature quantity) rather than the registered image data itself. The registered image storage section 125 may be realized by using the storage apparatus 14 described above (see FIG. 1). Alternatively, the registered image storage section 125 may be realized by a database or the like provided outside the first information processing apparatus 1. The registered image storage unit 125 is configured to store a plurality of pieces of registered image data. The index calculation unit 120 may calculate N integrated feature quantities or N scores by using the first feature quantity extracted from the time-series image data and N second feature quantities respectively extracted from N pieces of registered image data. The registered image data stored in the registered image storage unit 125 may be, for example, the face image data on a registered user to be used for face authentication/facial recognition. In this case, the integrated feature quantity and the score calculated by the index unit 120 are indices indicating a degree of matching between the face of the target included in the time-series image data and the face of the registered user.

The likelihood ratio calculation unit 130 is configured to calculate a likelihood ratio, based on the integrated feature quantity or score calculated by the index calculation unit 120. The likelihood ratio calculated by the likelihood ratio calculation unit 130 is a value indicating the likelihood of a class to which the time-series image data belong. For example, the likelihood ratio calculation unit 130 calculates a likelihood ratio indicating the likelihood that the time-series image data belong to each of a plurality of registered classes set for respective pieces of registered image data. In this case, the likelihood ratio calculation unit 130 may calculate a plurality of likelihood ratios respectively corresponding to the plurality of registered classes (i.e., the same number of likelihood ratios as the number of the registered classes). For example, in a case where N pieces of registered image data are registered in the registered image storage unit 125, N registered classes corresponding to them may be set, and the likelihood ratio calculation unit 130 may calculate N likelihood ratios respectively corresponding to the N registered classes. Furthermore, the likelihood ratio calculation unit 130 calculates a likelihood ratio indicating the likelihood that the time-series image data belong to an unregistered class to which the time-series image data belong, in a case where the time-series image data do not belong to any registered class (i.e., in a case where they are unregistered). A specific method used by the likelihood ratio calculation unit 130 to calculate the likelihood ratio is not particularly limited. The likelihood ratio calculation unit 130 may calculate the likelihood ratio by using various existing methods. For example, the likelihood ratio calculation unit 130 may calculate the likelihood ratio by using an estimation model that is machine-learned in advance (specifically, a neural network learned by deep learning, etc.). The likelihood ratio calculation unit 130 may calculate the likelihood ratio based on two or more consecutive pieces of image data of the time-series image data. For example, the likelihood ratio calculation unit 130 may calculate the likelihood ratio by using the integrated feature quantity or score calculated from the image data acquired in the past, in addition to the integrated feature quantity or score calculated from the image data acquired immediately before. The likelihood ratio calculated by the likelihood ratio calculation unit 130 is outputted to the class determination unit 140.

The class determination unit 140 is configured to determine the class to which the time-series image data belong, based on the likelihood ratio calculated by the likelihood ratio calculation unit 130. That is, the class determination unit 140 is configured to perform class classification processing based on the likelihood ratio. Specifically, the class determination unit 140 compares the likelihood ratio corresponding to each class calculated by the likelihood ratio calculation unit 130 with a threshold set in advance, thereby determining to the class to which the time-series image data belong. The class determination Specifically, the class determination unit 140 nit 140 uses two different thresholds depending on a type of the likelihood ratio. Specifically, the class determination unit 140 uses a class threshold for a likelihood ratio corresponding to the registered class (hereinafter referred to as a “first likelihood ratio” as appropriate). The class determination unit 140 uses an unregistration threshold for a likelihood ratio corresponding to the unregistered class (hereinafter referred to as a “second likelihood ratio” as appropriate). The class threshold and the unregistration threshold are set to have different values. The class determination unit 140 determines that the time-series image data belong to the registered class corresponding to the registered image data in a case where the first likelihood ratio reaches the class threshold. That is, the class determination unit 140 determines that the time-series image data match any one of the pieces of registered image data in a case where the first likelihood ratio reaches the class threshold. On the other hand, the class determination unit 140 determines that the time-series image data belong to the unregistered class (in other words, do not belong to any registered class) in a case where the second likelihood ratio reaches the unregistration threshold. That is, the class determination unit 140 determines that the time-series image data do not match any one of the pieces of registered image data (in other words, they are unregistered) in a case where the second likelihood ratio reaches the unregistration threshold.

### (Flow of Operation)

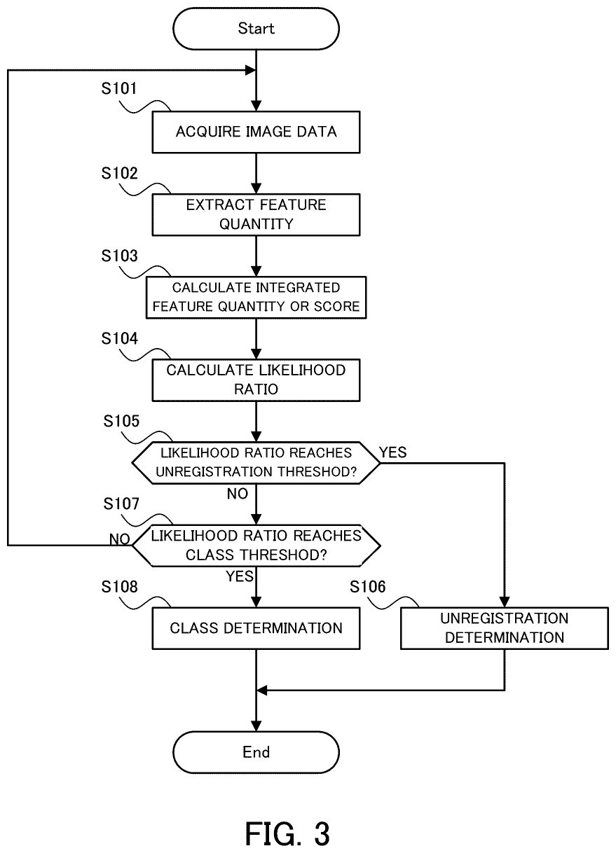

Next, with reference to FIG. 3, a flow of operation of the first information processing apparatus I will be described. FIG. 3 is a flowchart illustrating the flow of the operation of the first information processing apparatus.

As illustrated in FIG. 3, when the operation of the first information processing apparatus 1 is started, first, the image acquisition unit 110 acquires the image data (step S101). The image data acquired here may be most recently captured one frame of image data of the time-series image data.

Then, the index calculation unit 120 extracts the first feature quantity from the image data acquired by the image acquisition unit 110 and extracts the second feature quantity from the registered image data read from the registered image storage unit 125 (step S102). Then, the index calculation unit 120 calculates the integrated feature quantity or score, based on the extracted first feature quantity and second feature quantity (step S103).

Then, the likelihood ratio calculation unit 130 calculates the likelihood ratio indicating the likelihood of the class to which the time-series image data belong, based on the integrated feature quantity or score calculated by the index calculation unit 120 (step S104). Specifically, the likelihood ratio calculation unit 130 calculates the first likelihood ratio corresponding to the registered class and the second likelihood ratio corresponding to the unregistered class.

Then, the class determination unit 140 determines whether or not the second likelihood ratio calculated by the likelihood ratio calculation unit 130 reaches the unregistration threshold (step S105). In a case where the second likelihood ratio reaches the unregistration threshold (step S105: YES), the class determination unit 140 determines that the time-series image data do not belong to any registered class (i.e., they are unregistered) (step S106). In this case, it is determined that the time-series image data do not match the registered image data (in other words, the target is an unregistered user), and the matching processing is ended.

On the other hand, in a case where the second likelihood ratio does not reach the unregistration threshold (step S105: NO), the class determination unit 140 determines whether or not the first likelihood ratio reaches the class threshold (step S107). In a case where the first likelihood ratio reaches the class threshold (step S107: YES), the class determination unit 140 determines that the time-series image data belong to the registered class (step S108). Specifically, the class determination unit 140 determines that the time-series image data belong to the registered class corresponding to the first likelihood ratio that exceeds the class threshold. In this case, it is determined that the time-series image data match the registered image data (in other words, the target is a registered user), and the matching processing is ended.

On the other hand, in a case where the first likelihood ratio does not reach the class threshold (step S107: NO), the processing is started again from the step S101. That is, the image data acquisition unit 110 acquires new image data (e.g., a next frame of image data), and the aforementioned series of processing steps are performed again. By repeating the processing as described above, the likelihood ratio calculated by the likelihood ratio calculation unit 130 gradually changes. Then, the determination processing (i.e., the matching processing) is continued until the likelihood ratio exceeds the class threshold or the unregistration threshold.

The first information processing apparatus 1 may be configured to perform various types of processing related to the target, based on a determination result of the class determination unit 140. For example, the first information processing apparatus 1 may be configured to perform processing of permitting or prohibiting passage of the target through a predetermined area, based on the determination result of the class determination unit 140. More specifically, in a case where the time-series image data are determined to match the registered image data, the first information processing apparatus 1 may control a gate disposed in a predetermined area to open, thereby permitting the target to pass through. In addition, in a case where it is determined that the time-series image data do not match the registered image data (i.e., they are unregistered), the first information processing apparatus 1 may control the gate disposed in the predetermined area to close, thereby prohibit the target from passing through.

### Operation Example

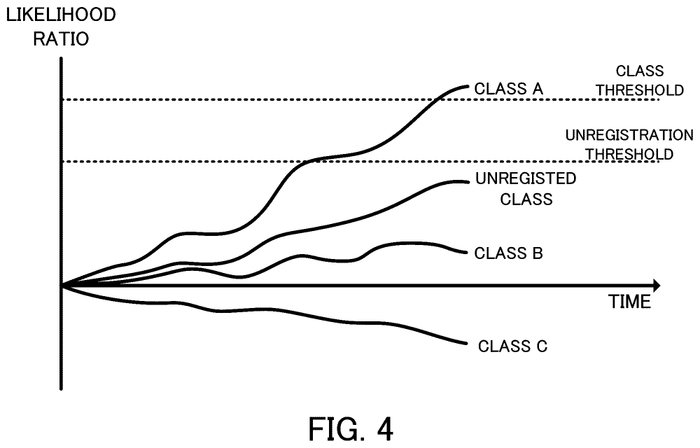

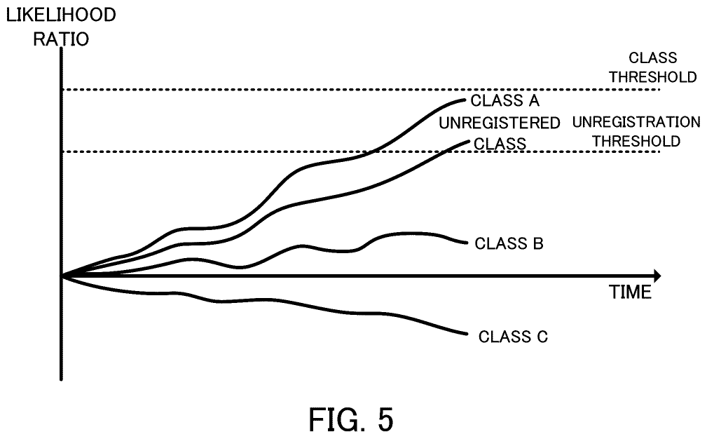

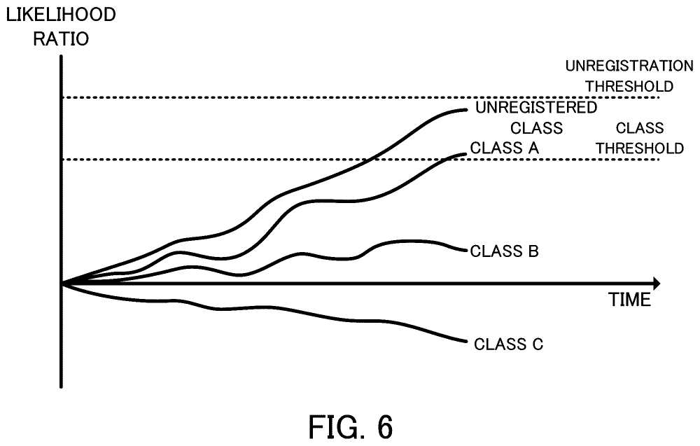

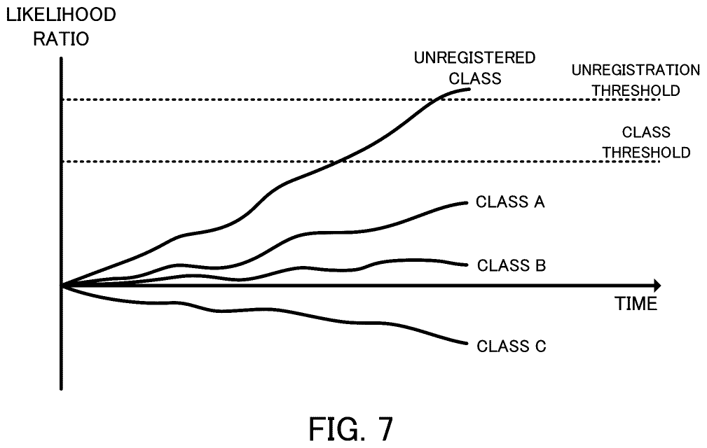

Next, with reference to FIG. 4 to FIG. 7, a specific operation example of the first information processing apparatus 1 (in particular, an example of an operation of determining the class to which time-series image data belong, based on the likelihood ratio) will be described. FIG. 4 is version 1 of a graph illustrating an example of the class threshold, the unregistration threshold, and the likelihood ratio in the first information processing apparatus. FIG. 5 is version 2 of a graph illustrating an example of the class threshold, the unregistration threshold, and the likelihood ratio in the first information processing apparatus. FIG. 6 is version 3 of a graph illustrating an example of the class threshold, the unregistration threshold, and the likelihood ratio calculated by the first information processing apparatus. FIG. 7 is version 4 of a graph illustrating an example of the class threshold, the unregistration threshold, and the likelihood ratio calculated by the first information processing apparatus.

In the examples illustrated in FIG. 4 and FIG. 5, registered image data A, registered image data B, and registered image data C are registered as the registered image data. Then, a class A, a class B, and a class C are set as registered classes respectively corresponding to the registered image data A, B, and C. Furthermore, an unregistered class is also set in addition to the registered classes.

The likelihood ratio calculation unit 130 calculates respective first likelihood ratios, based on the image data acquired by the image acquisition unit 110 and the registered image data A, B, and C. That is, the likelihood ratio calculation unit 130 calculates a first likelihood ratio corresponding to the class A, a first likelihood ratio corresponding to the class B, and a first likelihood ratio corresponding to the class C. The likelihood ratio calculation unit 130 also calculates a second likelihood ratio corresponding to the unregistered class. These likelihood ratios gradually change over time (i.e., as the image data are sequentially acquired).

Especially in the examples illustrated in FIG. 4 and FIG. 5, the class threshold for determining whether or not the image data belong to the registered class is set to have a higher value than that of the unregistration threshold for determining whether or not the image data belong to the unregistered class.

In the example illustrated in FIG. 4, the first likelihood ratio corresponding to the class A reaches the class threshold. On the other hand, the first likelihood ratios corresponding to the classes B and C do not reach the class threshold. Furthermore, the second likelihood ratio corresponding to the unregistered class does not reach the unregistration threshold. In such a case, the time-series image data acquired by the image acquisition unit 110 are determined to belong to the class A. That is, the time-series image data are determined to match the registered image data A and not to match the registered image data B and C. As a result, obtained is such a matching result that the target included in the time-series image data is a user corresponding to the registered image data A.

In the example illustrated in FIG. 5, all of the first likelihood ratios corresponding to the classes A, B, and C do not reach the class threshold. On the other hand, the second likelihood ratio corresponding to the unregistered class reaches the unregistration threshold. In such a case, the time-series image data acquired by the image acquisition unit 110 are determined to belong to the unregistered class. In other words, the time-series image data are determined to unregistered image data that do not belong to none of the classes A, B, and C. Therefore, the time-series image data are determined to not match any one of the registered image data A, B, and C. As a result, obtained is such a matching result that the target included in the time-series image data is an unregistered user.

As in FIG. 4 and FIG. 5, when the class threshold is set to have a higher value than that of the unregistration threshold, it is harder to determine that the time-series image data belong to the registered class, while it is easier to determine that the time-series image data belong to the unregistered class. As a result, in a case where a correct answer of the class to which the time-series image data belong is the “unregistered class,” a correct answer rate of unregistration determination increases. Furthermore, in a case where the correct answer of the class to which the time-series image data belong is the “registered class,” the correct answer rate of the unregistration determination decreases. Therefore, false acceptance in the matching processing (determining that matching image data exist in the registered image data even though they do not) decreases, and false rejection (determining that matching image data do not exist in the registered image data even though they do) increases.

In the examples illustrated in FIG. 6 and FIG. 7, most conditions are the same as those illustrated in FIG. 4 and FIG. 5, but the class threshold for determining whether or not the image data belong to the registered class is set to have a lower value than that of the unregistration threshold for determining whether or not the image data belong to the unregistered class.

In the example illustrated in FIG. 6, the second likelihood ratio corresponding to the unregistered class is higher than the other first likelihood ratios, but does not reach the unregistration threshold. On the other hand, the first likelihood ratio corresponding to the class A is lower than the second likelihood ratio, but reaches the class threshold. In such a case, the time-series image data acquired by the image acquisition unit 110 are determined to belong to the class A. That is, the time-series image data are determined to match the registered image data A and not to match the registered image data B and C. As a result, obtained is such a matching result that the target included in the time-series image data is a user corresponding to the registered image data A.

In the example illustrated in FIG. 7, none of the first likelihood ratios corresponding to the classes A, B, and C reach the class threshold. On the other hand, the second likelihood ratio corresponding to the unregistered class reaches the unregistration threshold. In such a case, the time-series image data acquired by the image acquisition unit 110 are determined to belong to the unregistered class. In other words, the time-series image data are determined to be unregistered image data that do not belong to any one of the classes A, B, and C. Therefore, the time-series image data are determined not to match any one of the registered image data A, B, and C. As a result, obtained is such a matching result that the target included in the time-series image data is an unregistered user.

As in FIG. 6 and FIG. 7, when the class threshold is set to have a lower value than that of the unregistration threshold, it is easier to determine that the time-series image data belong to the registered class, while it is harder to determine that the time-series image data belong to the unregistered class. As a result, in a case where the correct answer of the class to which the time-series image data belong is the “unregistered class,” the correct answer rate of the unregistration determination decreases. Furthermore, in a case where the correct answer of the class to which the time-series image data belong is the “registered class,” the correct answer rate of the unregistration determination increases. Therefore, the false acceptance in the matching processing increases, and the false rejection decreases.

### Technical Effect

Next, a technical effect obtained by the first information processing apparatus 1 will be described.

As described in FIG. 1 to FIG. 7, in the first information processing apparatus 1, the class threshold for determining whether or not the time-series image data belong to the registered class and the unregistration threshold for determining whether or not the time-series image data belong to the unregistered class, are set to have different values. In this way, it is possible to adjust the ratio of the false acceptance and the false rejection, depending on to what values the class threshold and the unregistration threshold are set to have.

### Second Example Embodiment

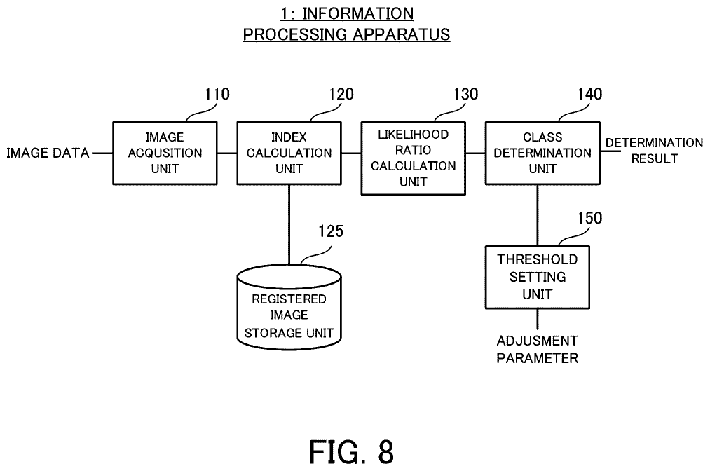

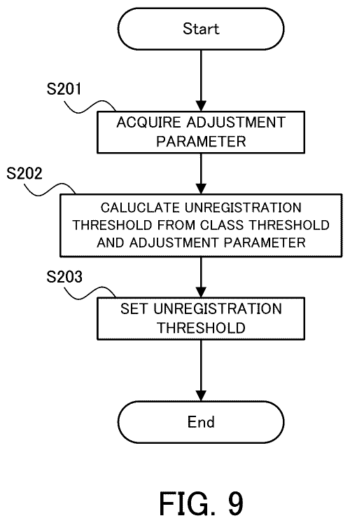

A second information processing apparatus I will be described with reference to FIG. 8 and FIG. 9. The second information processing apparatus 1 partially differs from the first information processing apparatus 1 described above in its configuration and operation, and may be the same as the first information processing apparatus 1 in the other parts. For this reason, a part differing from the first example embodiment already described will be described in detail below, and a description of the other overlapping parts will be omitted as appropriate.

### Functional Configuration

First, with reference to FIG. 8, a functional configuration of the second information processing apparatus 1 will be described. FIG. 8 is a block diagram illustrating the functional configuration of the second information processing apparatus. In FIG. 8, the same components as those described in FIG. 2 carry the same reference numerals.

In FIG. 8, the second information processing apparatus 1 includes, as components for realizing its functions, the image acquisition unit 110, the index calculation unit 120, the registered image storage unit 125, the likelihood ratio calculation unit 130, the class determination unit 140, and a threshold setting unit 150. That is, the second information processing apparatus 1 further includes the threshold setting unit 150 in addition to the configuration described in the first example embodiment (see FIG. 2). The threshold setting unit 150 may be a processing block realized by the above-mentioned processor 11 (see FIG. 1).

The threshold setting unit 150 is configured to set the unregistration threshold to be used by the class determination unit 140. Specifically, the threshold setting unit 150 sets the unregistration threshold, based on the class threshold. As a result, the class threshold and the unregistration threshold are correlated. For example, the threshold setting unit 150 may calculate the unregistration threshold by using the class threshold and an adjustment parameter. The adjustment parameter is a parameter for trading off the false acceptance and the false rejection, and may be determined based on a desired ratio to the false acceptance and the false rejection.

In a case where the class threshold is λ1, the unregistration threshold is λ2, and the adjustment parameter is δ, the threshold setting unit 150 may calculate and set the unregistration threshold λ2 as λ2=λ1+δ. That is, the unregistration threshold λ2 may be set as a value obtained by adding the adjustment parameter δ to the class threshold λ1. Described here is an example of adding the adjustment parameter, but the class threshold λ1 may be multiplied by the adjustment parameter to calculate the unregistration threshold. Alternatively, a more complex function may be used to calculate the unregistration threshold.

The class threshold λ1 may be set in advance based on a speed and accuracy required for the determination. For example, lowering the class threshold reduces a time required to determine that the image data belong to the registered class, thereby increasing the determination speed. On the other hand, raising the class threshold increases the time required to determine that the image data belong to the registered class (i.e., allows a longer time for the determination), thereby increasing the determination accuracy. As described above, the class threshold functions as a parameter for adjusting the speed and accuracy of the determination. Therefore, by using the class threshold and the unregistration threshold set based on the adjustment parameter, it is possible to adjust the ratio of the false acceptance and the false rejection, as well as the speed and accuracy of the determination.

### Threshold Setting Operation

Next, with reference to FIG. 9, a flow of a threshold setting operation (i.e., an operation of the threshold setting unit 150 when setting the unregistration threshold) in the second information processing apparatus 1 will be described. FIG. 9 is a flowchart illustrating the flow of the threshold setting operation in the second information processing apparatus.

As illustrated in FIG. 9, when the operation of the second information processing apparatus 1 is started, first, the threshold setting unit 150 acquires the adjustment parameter (step S201). The adjustment parameter may be inputted by a user of the apparatus, for example. In this case, the user may input a value of the adjustment parameter itself, or may input the desired ratio of the false acceptance and the false rejection.

Then, the threshold setting unit 150 calculates the unregistration threshold by using the class threshold set in advance and the adjustment parameter acquired in the step S201 (step S202). Then, the threshold setting unit 150 outputs the calculated value of the unregistration threshold to the class determination unit 140 and sets it as the threshold to be used for determining the likelihood ratio (step S203).

The above-described threshold setting operation typically needs to be performed only once, before the start of the operation of the second information processing apparatus 1. However, in a situation in which the ratio of the false acceptance and the false rejection needs to be changed, the threshold setting operation may be performed again. In this case, the value of the adjustment parameter may be changed and the aforementioned series of operations may be performed.

### Technical Effect

Next, a technical effect obtained by the second information processing apparatus 1 will be described.

As described in FIG. 6 and FIG. 7, in the second information processing apparatus 1, the class threshold and the unregistration threshold are set as values that are correlated with each other. In this way, it is possible to set an appropriate unregistration threshold, depending on the value of the class threshold. In this case, by using the adjustment parameter for trading off the false acceptance and the false rejection, it is possible to appropriately adjust the false acceptance and the false rejection in the determination processing. For example, by calculating the unregistration threshold λ2 as λ2=λ1+δ, it is possible to easily and accurately calculate the unregistration threshold from the class threshold.

### Third Example Embodiment

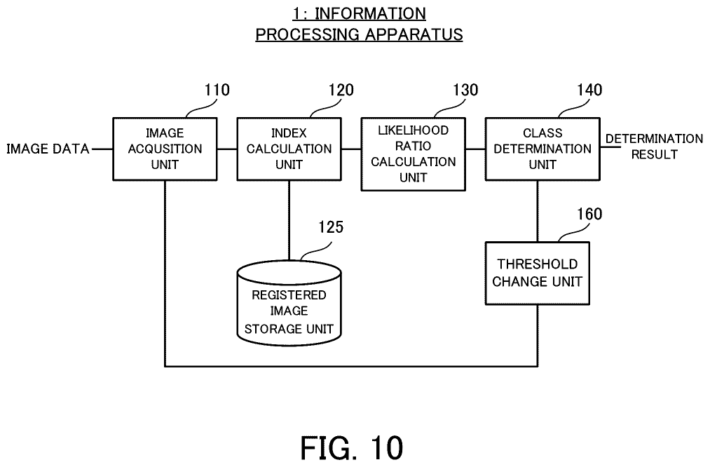

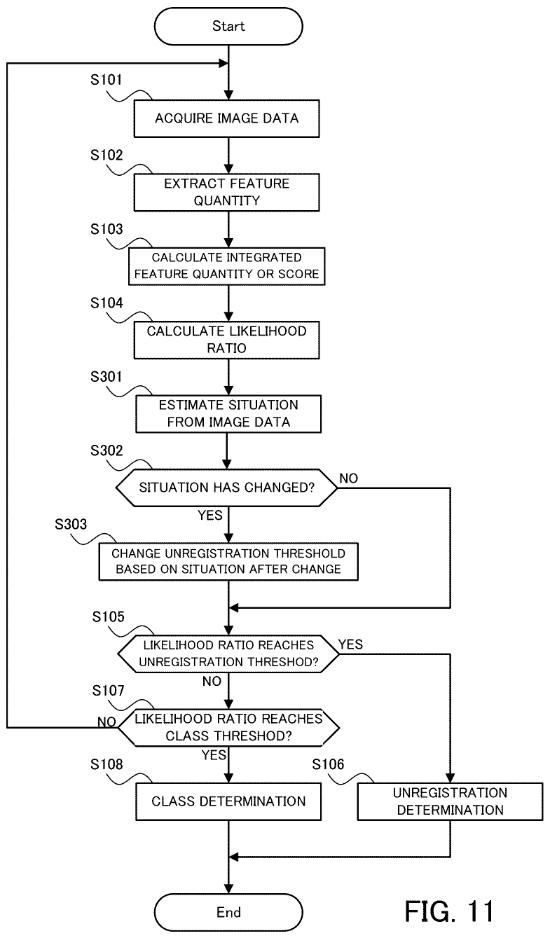

A third information processing apparatus I will be described with reference to FIG. 10 and FIG. 11. The third information processing apparatus 1 partially differs from the first and second information processing apparatus 1 described above in its configuration and operation, and may be the same as the first and second information processing apparatus 1 in the other parts. For this reason, a part differing from each of the example embodiments described above will be described in detail below, and a description of the other overlapping parts will be omitted as appropriate.

### Functional Configuration

First, with reference to FIG. 10, a functional configuration of the third information processing apparatus 1 will be described. FIG. 10 is a block diagram illustrating the functional configuration of the third information processing apparatus. In FIG. 10, the same components as those described in FIG. 2 carry the same reference numerals.

In FIG. 10, the third information processing apparatus 1 includes, as components for realizing its functions, the image acquisition unit 110, the index calculation unit 120, the registered image storage unit 125, the likelihood ratio calculation unit 130, the class determination unit 140, and a threshold change unit 160. That is, the third information processing apparatus 1 further includes the threshold change unit 160 in addition to the configuration described in the first example embodiment (see FIG. 2). The threshold change unit 160 may be a processing block realized by the above-mentioned processor 11 (see FIG. 1).

The threshold change unit 160 is configured to change the unregistration threshold to be used by the class determination unit 140. Specifically, the threshold change unit 160 is configured to dynamically change the unregistration threshold in response to the time-series image data acquired by the image acquisition unit 110. As previously described, the unregistration threshold has a function of adjusting the ratio of the false acceptance and the false rejection in the matching processing. Therefore, by dynamically changing the unregistration threshold, it is possible to change the ratio of the false acceptance and the false rejection during the determination. However, there are not many cases where the ratio of the false acceptance and the false rejection is changed in the middle of the matching processing. On the other hand, in a case where a situation in which the matching processing is performed changes significantly, the ratio of the false acceptance and the false rejection may change unintentionally. In such a case, the threshold change unit 160 may change the unregistration threshold such that the ratio of the false acceptance and the false rejection does not change in response to the change in the situation.

For example, the threshold change unit 160 may estimate a moving direction of the target included in the time-series image data (i.e., a flow of people at a location where the time-series image data are captured) and may change the unregistration threshold based on the estimated moving direction of the target. A change in the moving direction of the target changes an orientation/direction of the target included in the time-series image data. For example, in a case where the time-series image data are face image data including a face of the target, the change in the moving direction of the target changes the orientation of the face of the target included in the face image data. In such a case, the change in the orientation of the face changes a matching rate, and as a result, the ratio of the false acceptance and the false rejection may change. Therefore, the threshold change unit 160 may change the unregistration threshold based on the moving direction of the target so as to reduce the change in the ratio of the false acceptance and the false rejection.

Alternatively, the threshold change unit 160 may estimate the orientation of the face of the target included in the time-series image data and may change the unregistration threshold based on the estimated orientation of the face of the target. For example, the threshold change unit 160 may change the unregistration threshold depending on whether the face of the target included in the time-series image data is facing right, left, or straight ahead. As described above, the change in the orientation of the face of the target changes the matching rate, and as a result, the ratio of the false acceptance and the false rejection may change. Therefore, the threshold change unit 160 may change the unregistration threshold based on the orientation of the face of the target so as to reduce the change in the ratio of the false acceptance and the false rejection.

The threshold change unit 160 may also change the class threshold, when changing the unregistration threshold. For example, the threshold change unit 160 may change both the class threshold and the unregistration threshold so as not to break the correlation between the class threshold and the unregistration threshold.

### (Flow of Operation)

Next, with reference to FIG. 11, a flow of operation of the third information processing apparatus 1 will be described. FIG. 11 is a flowchart illustrating the flow of the operation of the third information processing apparatus. In FIG. 11, the same steps as those illustrated in FIG. 3 carry the same reference numerals.

As illustrated in FIG. 11, when the operation of the third information processing apparatus 1 is started, first, the image acquisition unit 110 acquires the image data (step S101).

Then, the index calculation unit 120 extracts the first feature quantity from the image data acquired by the image acquisition unit 110 and extracts the second feature quantity from the registered image data read from the registered image storage unit 125 (step S102). Then, the index calculation unit 120 calculates the integrated feature quantity or score, based on the extracted first feature quantity and second feature quantity (step S103).

Then, the likelihood ratio calculation unit 130 calculates the likelihood ratio indicating the likelihood of the class to which the time-series image data belong, based on the integrated feature quantity or score calculated by the index calculation unit 120 (step S104). Specifically, the likelihood ratio calculation unit 130 calculates the first likelihood ratio corresponding to the registered class and the second likelihood ratio corresponding to the unregistered class.

Then, the threshold change unit 160 estimates a current situation (e.g., the moving direction of the target and the orientation of the face described above) from the image data acquired by the image acquisition unit 110 (step S301). Then, the threshold change unit 160 determines whether or not the estimated situation has changed from a situation immediately before (step S302). For example, in a case where the target continues to move from right to left as seen from a camera and then begins to move from left to right, the threshold change unit 160 may determine that the situation has changed. Alternatively, in a case where the face of the target continues to be captured from the front and then begins to be captured from the right side, the threshold change unit 160 may determine that the situation has changed.

In a case where it is determined that the situation has changed (step S302: YES), the threshold change unit 160 changes the unregistration threshold based on the situation after the change (step S303). For example, the threshold change unit 160 may change the unregistration threshold so as to reduce the change in the ratio of the false acceptance and the false rejection, which is caused by the change in the situation. The threshold change unit 160 may, for example, change the adjustment parameter δ, thereby changing the unregistration threshold. In a case where it is determined that the situation has not changed (step S302: NO), the step S303 may be omitted. That is, the unregistration threshold may not be changed.

Then, the class determination unit 140 determines whether or not the second likelihood ratio calculated by the likelihood ratio calculation unit 130 reaches the unregistration threshold (step S105). Here, the class determination unit 140 uses the unregistration threshold changed by the threshold change unit 150. In a case where the unregistration threshold is changed in the step S303, the class determination unit 140 performs the determination by using the unregistration threshold after the change. In a case where the second likelihood ratio reaches the unregistration threshold (step S105: YES), the class determination unit 140 determines that the time-series image data do not belong to any registered class (i.e., they are unregistered) (step S106). In this case, it is determined that the time-series image data do not match the registered image data (in other words, the target is an unregistered user), and the matching processing is ended.

On the other hand, in a case where the second likelihood ratio does not reach the unregistration threshold (step S105: NO), the class determination unit 140 determines whether or not the first likelihood ratio reaches the class threshold (step S107). In a case where the likelihood ratio reaches the class threshold (step S107: YES), the class determination unit 140 determines that the time-series image data belong to the registered class (step S108). Specifically, the class determination unit 140 determines that the time-series image data belong to the registered class corresponding to the first likelihood ratio that exceeds the class threshold. In this case, it is determined that the time-series image data match the registered image data (in other words, the target is a registered user), and the matching processing is ended.

On the other hand, in a case where the first likelihood ratio does not reach the class threshold (step S107: NO), the processing is started again from the step S101. That is, the image data acquisition unit 110 acquires new image data (e.g., a next frame of image data), and the aforementioned series of processing steps are performed again.

### Technical Effect

Next, a technical effect obtained by the third information processing apparatus 1 is described.

As described in FIG. 10 and FIG. 11, in the third information processing apparatus 1, the unregistration threshold is changed in response to the time-series image data. In this way, it is possible to change the unregistration threshold to have an appropriate value, depending on a situation in which the time-series image data are acquired. Therefore, it is possible to perform the determination processing using the unregistration threshold, more appropriately.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal. The program may be provided to a user in a form of Saas (Software as a Service), for example.

### <Supplementary Notes>

The example embodiments described above may be further described as, but not limited to, the following Supplementary Notes below.

### (Supplementary Note 1)

An information processing apparatus according to Supplementary Note 1 is an information processing apparatus including: an acquisition unit that acquires time-series image data; an index calculation unit that calculates an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; a likelihood ratio calculation unit that calculates a likelihood ratio indicating a likelihood of a class to which the time-series image data belong, based on the integrated feature quantity or the score; and a determination unit that determines that the time-series image data belong to a registered class corresponding to the registered image data in a case where the likelihood ratio reaches a first threshold, and determines that the time-series image data belong to an unregistered class indicating that the time-series image data are not registered in advance, in a case where the likelihood ratio reaches a second threshold that is different from the first threshold.

### (Supplementary Note 2)

An information processing apparatus according to Supplementary Note 2 is the information processing apparatus according to Supplementary Note 1, wherein the first threshold and the second threshold are correlated.

### (Supplementary Note 3)

An information processing apparatus according to Supplementary Note 3 is the information processing apparatus according to Supplementary Note 2, wherein the second threshold is a value calculated by using the first threshold and an adjustment parameter for trading off false acceptance and false rejection.

### (Supplementary Note 4)

An information processing apparatus according to Supplementary Note 4 is the information processing apparatus according to Supplementary Note 2, wherein in a case where the first threshold is λ1, the second threshold is λ2, and the adjustment parameter is δ, the second threshold λ2 is a value calculated as λ2=λ1+δ.

### (Supplementary Note 5)

An information processing apparatus according to Supplementary Note 5 is the information processing apparatus according to any of Supplementary Notes 1 to 4, further comprising a threshold change unit that dynamically changes the second threshold in response to the time-series image data acquired.

### (Supplementary Note 6)

An information processing apparatus according to Supplementary Note 6 is the information processing apparatus according to Supplementary Note 5, wherein the time-series image data include a moving target, and the threshold change unit changes the second threshold, based on a moving direction of the target at a location where the time series image data are acquired.

### (Supplementary Note 7)

An information processing apparatus according to Supplementary Note 7 is the information processing apparatus according to Supplementary Note 5, wherein the time-series image data include a face of a target, and the threshold change unit changes the second threshold, based on an orientation of the face included in the time-series image data.

### (Supplementary Note 8)

An information processing method according to Supplementary Note 8 is an information processing method that is executed by at least one computer, the information processing including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a first threshold, and determining that the time-series image data belong to an unregistered class indicating that the time-series image data are not registered in advance, in a case where the likelihood ratio reaches a second threshold that is different from the first threshold.

### (Supplementary Note 9)

A computer program according to Supplementary Note 9 is a computer program that allows at least one computer to execute an information processing method, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a first threshold, and determining that the time-series image data belong to an unregistered class indicating that the time-series image data are not registered in advance, in a case where the likelihood ratio reaches a second threshold that is different from the first threshold.

### (Supplementary Note 10)

A non-transitory recording medium according to Supplementary Note 10 is a non-transitory recording medium on which a computer program that allows at least one computer to execute an information processing method is recorded, the information processing method including: acquiring time-series image data; calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity; calculating a likelihood ratio indicating a likelihood of a class to which the time-series image data belong, based on the integrated feature quantity or the score; and determining that the time-series image data belong to a registered class corresponding to the registered image data in a case where the likelihood ratio reaches a first threshold, and determining that the time-series image data belong to an unregistered class indicating that the time-series image data are not registered in advance, in a case where the likelihood ratio reaches a second threshold that is different from the first threshold.

The present disclosure is not limited to the above-described examples and is allowed to be changed, if desired, without departing from the essence or spirit of the invention which can be read from the claims and the entire specification. An information processing apparatus, an information processing method, a computer program, and a non-transitory recording medium with such changes, are also included in the technical concepts of the present disclosure.

### DESCRIPTION OF REFERENCE NUMERALS

1 Information processing apparatus
11 Processor
12 RAM
13 ROM
14 Storage apparatus
15 Input apparatus
16 Output apparatus
17 Data bus
110 Image acquisition unit
120 Index calculation unit
125 Registered image storage unit
130 Likelihood ratio calculation unit
140 Class determination unit
150 Threshold setting unit
160 Threshold change unit

What is claimed is:

1. An information processing apparatus comprising:
at least one memory that is configured to store instructions; and
at least one processor that is configured to execute the instructions to:
acquire time-series image data;
calculate an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculate a likelihood ratio indicating a likelihood of a class to which the time-series image data belong, based on the integrated feature quantity or the score; and
determine that the time-series image data belong to a registered class corresponding to the registered image data in a case where the likelihood ratio reaches a first threshold, and determines that the time-series image data belong to an unregistered class indicating that the time-series image data are not registered in advance, in a case where the likelihood ratio reaches a second threshold that is different from the first threshold.

2. The information processing apparatus according to claim 1, wherein the first threshold and the second threshold are correlated.

3. The information processing apparatus according to claim 2, wherein the second threshold is a value calculated by using the first threshold and an adjustment parameter for trading off false acceptance and false rejection.

4. The information processing apparatus according to claim 2, wherein
in a case where the first threshold is λ1, the second threshold is λ2, and the adjustment parameter is δ,
the second threshold λ2 is a value calculated as λ2=λ1+δ.

5. The information processing apparatus according to claim 1, wherein the at least one processor is configured to execute the instructions to dynamically change the second threshold in response to the time-series image data acquired.

6. The information processing apparatus according to claim 5, wherein
the time-series image data include a moving target, and
the at least one processor is configured to execute the instructions to change the second threshold, based on a moving direction of the target at a location where the time series image data are acquired.

7. The information processing apparatus according to claim 5, wherein
the time-series image data include a face of a target, and
the at least one processor is configured to execute the instructions to change the second threshold, based on an orientation of the face included in the time-series image data.

8. An information processing method that is executed by at least one computer, the information processing comprising:
acquiring time-series image data;
calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculating a likelihood ratio indicating a likelihood of a class to which the time-series image data belong, based on the integrated feature quantity or the score; and
determining that the time-series image data belong to a registered class corresponding to the registered image data in a case where the likelihood ratio reaches a first threshold, and determining that the time-series image data belong to an unregistered class indicating that the time-series image data are not registered in advance, in a case where the likelihood ratio reaches a second threshold that is different from the first threshold.

9. A non-transitory recording medium on which a computer program that allows at least one computer to execute an information processing method is recorded, the information processing method including:
acquiring time-series image data;
calculating an integrated feature quantity or a score, the integrated feature quantity being obtained by integrating a first feature quantity that is a feature quantity of the time-series image data and a second feature quantity that is a feature quantity of registered image data registered in advance, the score indicating a degree of similarity between the first feature quantity and the second feature quantity;
calculating a likelihood ratio indicating a likelihood of a class to which the time-series image data belong, based on the integrated feature quantity or the score; and
determining that the time-series image data belong to a registered class corresponding to the registered image data in a case where the likelihood ratio reaches a first threshold, and determining that the time-series image data belong to an unregistered class indicating that the time-series image data are not registered in advance, in a case where the likelihood ratio reaches a second threshold that is different from the first threshold.
